(19) United States
(12) Patent Application Publication
(10) Pub. No.: US 2007/0294139 A1
(43) Pub. Date: Dec. 20, 2007

(54) PickARide.Com -Network of goods and services

(76) Inventor: Michael Habashy, Astoria, NY (US)

Correspondence Address: Michael Habashy, 35-04 29 St, Astoria, NY, 11106, US

(21) Appl. No.: 11/425,176

(22) Filed: Jun. 20, 2006

(51) Int. Cl. G06Q 30/00

(52) U.S. Cl. 705/27; 705/14

(57) ABSTRACT

The invention relates to providing a communication method and system of connecting perspective clients to various service/goods providers that are mobile and non-mobile. Part of this invention will be a communication channel between a consumer of goods and services and a provider of goods and services. This invention will further provide information about the perspective clients (consumer profile) as to what selectively advertised goods and services in a given area are needed by consumer via SMS text messaging and email technology.

Scenario A: The system and/or website will hold information about goods and services such as shoe stores and taxis in New York City. A person visiting New York City and wishes to purchase shoes will go wish to go to 34th St and Broadway. They will log onto the website and select a couple of the nearby taxis in the area. They will be able to read a little biography on the driver and what other passengers have said about them. They will be able to negotiate a price, location and destination that they wish. They will also have the option to get information or “flyers” about certain sales or goods in the destination that they will be arriving at via SMS/Short Text Messaging and/or email. A vendor or goods provider in some cases will be able to get feedback on effectiveness of advertising campaign based upon global positioning system receiver located in wireless phone device.

Scenario B: A group of guys which to rent a boat in Montauk, N.Y. for the purpose of fishing. They go to the website and/or system and look up fishing services in Montauk, N.Y. They are able to reserve a local mini-bus and driver via sms text messaging to negotiate a time and price to be picked up and dropped off in Montauk, N.Y. They further get the background on various fishing boat operators in Montauk which they contact via SMS Text Messaging. This works well for the fishing operators because they are constantly out at sea and not in the office.

They are further contacted with deli and fishing stores locally in Montauk of specials that they are running. They are able to present sms-text messaging coupons for goods and services on their wireless phone.

1. A website and or system will hold a list of goods and services in a given area. A consumer who wishes to travel to a given locale will go to website or WAP enabled device or cellular phone to schedule services to get to certain location. They will be able to select from a list of transportation providers in the vicinity. They will further be informed of other goods and services in the area via SMS text messaging and email.

2. A website and or system of claim 1, wherein will comprise a list of transportation professionals that operate various types of land, sea, and air vehicles. The system will include a method of contacting these providers anywhere via SMS Text Messaging and emails to their mobile devices/cellular phones. This invention will free the sole proprietor to focus on providing services instead of tying themselves into getting customers which can be a time consuming task.

3. A website and or system of claim 1, wherein will comprise of detailed information of person or persons operating such vehicles and comments made by other consumers who have used their service in the past.

4. A website and or system of claim 1, will enable consumers to negotiate a transportation fee and conditions directly with the operator of land, sea, or air vehicle.

5. A website and or system of claim 1, wherein will hold timely advertisements and/or “flyers” of service and goods providers in the given source and destination locations. These advertisements will be sent via SMS text messaging and/or email to the consumer.

6. A website and/or system of claim 1 will use existing gps information in wireless device or system to provide feed back to the website and/or system.

7. A website and/or system of claim 1 will have a competitive/bidding pricing system will be used for pricing advertising campaigns of goods and service providers.
